(19) United States
(12) Patent Application Publication
(10) Pub. No.: US 2016/0025874 A1
(43) Pub. Date: Jan. 28, 2016

(54) Method for Acquiring Passive Seismic Data Using an Outlier Array

(71) Applicant: Daniel D. Hollis, San Gabriel, CA (US)

(72) Inventor: Daniel D. Hollis, San Gabriel, CA (US)

(21) Appl. No.: 14/339,678

(22) Filed: Jul. 24, 2014

(51) Int. Cl. G01V 1/00

(52) U.S. Cl. CPC G01V 1/003

(57) ABSTRACT

Disclosed herein are various embodiments of a method for designing and using a sparse static receiver array outside of the boundary of a controlled-source 3D seismic survey for the purpose of acquiring a useful passive seismic dataset. Receivers in the passive seismic survey outside the boundary of the controlled source seismic survey are positioned so as to extend the coverage of the passive seismic survey to form an “Outlier Array”. These receivers are positioned as required to obtain adequate coverage of the subsurface for various types of analysis that may be performed on passive seismic data. Outlier Arrays may be combined with Backbone Arrays for optimal coverage of the survey area. Data from the passive seismic receivers is recorded for the duration of the controlled source seismic survey. Combining passive seismic data acquisition with a controlled source seismic survey allows more information to be obtained about the subsurface of the earth.

### CROSS REFERENCE TO RELATED APPLICATIONS

This application is related to the copending U.S. patent application Ser. No. 14/339,660 to Daniel D. Hollis entitled “Method for Acquiring Passive Seismic Data Using a Backbone Array”, filed 24 Jul. 2014, attorney Docket No. NS101P.

### FIELD

Various embodiments described herein relate to the field of seismic data acquisition and processing, and devices, systems and methods associated therewith.

### BACKGROUND

The science of earthquake seismology, that is, the detection of earthquakes and the energy they release goes back several centuries. Analyzing the energy released by earthquakes and received at remote sensing stations can provide much useful information about the interior of the earth. It is only in the last 100 years that exploration seismology has been used to obtain information about the near surface of the earth, primarily in the course of exploration for hydrocarbons and minerals. Exploration seismology traces its origins back to World War I. When huge artillery guns were fired, the recoil sent energy into the earth, and this energy propagated through the earth in all directions. By detecting this energy and estimating how fast it traveled through the earth, it was possible to determine how far away the gun was located. Using several listening stations, the location of the gun could be determined by triangulation. In the 1920s and 1930s techniques were developed to use a controlled energy source, usually an explosive such as dynamite, together with several sensitive receivers such as seismometers or geophones to obtain an image of the subsurface of the earth.

In early land seismic exploration, 12, 24 or even 48 receivers or groups of receivers were arranged along a straight line. The seismic source was activated, and data recorded for several seconds after the activation. Then by either physically moving the groups of receivers, or altering the setting of a multi-position switch, the pattern of receivers was moved further along the straight line for the next activation of the source. As this process was repeated multiple times, an image of the subsurface of the earth underneath the straight line was gradually built up. By acquiring data along multiple lines arranged in a grid pattern, the geophysicists and geologists could construct a picture of the subsurface of the earth within a surveyed area.

After the introduction of digital recording technology, the number of receiver groups rapidly increased. With the introduction of equipment that could record data from hundreds or even thousands of receiver groups, the next step was to arrange the receivers in a grid rather than a straight line, in order to produce a true three-dimensional picture of the subsurface of the earth. In a typical seismic survey, more receivers are placed in position than are recorded for any given source activation. Computer controlled switches determine which of the receivers are being recorded for any given source activation. For a small seismic survey, it may be possible to put all of the receivers in place and then record the entire survey. For larger seismic surveys, receivers are positioned within an area be surveyed, and as the seismic source activation points move across the surface of the earth, the receivers behind the seismic source are picked up and repositioned in front of the seismic source.

The reasons for this are primarily economic. To cover a large area requires an investment in a huge number of receivers, many of which would be positioned too far away from a given activation of the seismic source to receive a useful signal. Many of these receivers would not even be connected to the recording equipment for most of the source activations. It would take a considerable amount of time to position all of the receivers, during which time the seismic source equipment and its operators would be idle. Then, during the acquisition of the seismic data, the crews who lay out and collect the receivers would be idle while the data is being collected. Clearly, this is inefficient. Therefore in a typical controlled source survey sufficient receivers will be positioned to cover the area within which a useful signal can be recorded from a seismic source at the starting position plus some number of additional source positions. Then as the location of the seismic source moves, the receivers are picked up and repositioned ahead of the source. The number of receivers needed is thus kept to a minimum, and both the receiver crew and the source/recording operators are employed efficiently.

In recent years the techniques described above have become known as “active seismic” or “controlled source seismic” data acquisition. This is to distinguish them from “passive seismic” data acquisition. Collecting passive seismic data combines features of both earthquake seismology and exploration seismology. Typically, an array of receivers covering a large areal extent is placed in position, and data recorded over a period of hours, days or even weeks. The term passive seismic is used because there is no controlled energy source. Instead, the energy recorded comes from earthquakes, the natural movement of fractures and faults within the earth, ambient noise, and from activities such as drilling, fracing and any active seismic surveys being conducted in the area. Because the level of energy recorded by passive seismic techniques is so low, and is often represented as negative values on the Richter scale, sophisticated data processing techniques are required in order to extract the locations of the sources of energy within the earth. These techniques are often referred to as “microseismic” data acquisition and processing.

Passive seismic techniques are frequently used to monitor fractures occurring in the subsurface of the earth as a result of hydraulic fracturing. Hydraulic fracturing is the process of creating or enhancing fractures in rock formations by pumping fluid at high pressure into a well bore, causing fractures to propagate in the surrounding geologic layers. Hydraulic fracturing causes seismic events that emit energy in the form of seismic waves. The magnitude of these seismic events is typically less than zero on the Richter scale. This seismic energy can be detected and mapped to show the location and the extent of the fractures created or enhanced by the hydraulic fracturing operation. Passive seismic monitoring is typically performed by placing arrays of instruments in wells or boreholes, or near or at the surface of the earth, in the vicinity of the hydraulic fracturing operation. The purpose of this passive seismic monitoring is to determine if the hydraulic fracturing has had the intended effects within the hydrocarbon-bearing rock formation, and whether there are any unintended effects, such as opening fractures into shallower layers or groundwater aquifers. Passive seismic monitoring is often performed in real time during a hydraulic fracturing operation, in which case the fracturing operation can be modified or stopped if unintended fracturing events are evident.

A recent trend is for passive or microseismic data to be acquired during controlled source seismic surveys of an area. Such a survey may be an exploratory survey, or it may be a survey conducted prior to drilling to identify hydrocarbon reserves and delineate the geology of the subsurface, in particular, the natural faults and fractures in the area. In some instances, the receivers from the passive seismic survey are left in place and used to collect data during the drilling, fracing and production phases of developing the hydrocarbon reserves.

Passive seismic surveys and controlled source surveys clearly have conflicting requirements for the configuration of the receivers. The controlled source survey requires densely spaced receivers over a limited area. The passive seismic survey requires more sparsely spaced receivers over a much wider area. As stated above, if the survey area is small, the receivers may be positioned to cover the entire survey area, and data recorded continuously for the duration of the controlled source survey and beyond. For larger surveys, typically only some of the planned passive seismic receiver locations actually contain receivers at the onset of the controlled source survey. This is a problem for the associated passive seismic survey. The passive seismic survey is further complicated as the receivers change position during the controlled source survey, and the receivers do not stay in any one location long enough to collect the quantity of data required for a passive seismic survey.

For a controlled source survey, receivers are positioned within the survey boundary and the source progresses through the survey area. This is sufficient to obtain an image of the subsurface below the survey area. It is usually not sufficient for a passive seismic survey under the survey area. Imaging passive seismic events at depths requires an array with dimensions on the surface that are two to four times the depth to be imaged, depending on the objectives of the passive seismic survey. This may require positioning some receivers outside of the boundaries of the controlled source seismic survey.

What is needed is a way to optimize the placement of the receivers to obtain the best possible passive seismic data while retaining the efficiency of the controlled source seismic survey.

### SUMMARY

In one embodiment there is provided a method for acquiring passive surface seismic data during a controlled source active seismic survey comprising: determining the number of receivers required to support the recording of an active seismic data set and a passive surface seismic data set, the receivers being capable of recording active and passive seismic data; deploying the receivers required to support the roll-along of an active receiver patch for recording controlled source seismic data in an initial active receiver patch and designating these receivers as active seismic data receivers; deploying receivers in an approximately uniform distribution within the entire survey area to support the acquisition of a passive seismic data set and designating these receivers as passive seismic data receivers; designating certain receivers within the initial active receiver patch as both active and passive receivers; deploying additional receivers outside of the boundaries of the survey area to support the acquisition of an optimized passive seismic data set and designating these receivers as passive seismic data receivers; initiating the recording of a passive surface seismic data set using the receivers designated as passive seismic data receivers; recording a controlled source seismic data set for the survey area using the receivers designated as active seismic data receivers and terminating the recording of the passive seismic data set.

Further embodiments are disclosed herein or will become apparent to those skilled in the art after having read and understood the specification and drawings hereof. This summary may be more fully appreciated with respect to the following description and accompanying figures and attachments.

### BRIEF DESCRIPTION OF THE DRAWINGS

Different aspects of the various embodiments of the invention will become apparent from the following specification, drawings and claims in which:

FIG. 1 shows an early two-dimensional seismic survey;

FIG. 2 shows the two-dimensional seismic survey recording data from a different set of receivers;

FIG. 3 shows a grid of two-dimensional seismic lines;

FIG. 4 shows a conceptual plan view of a three-dimensional seismic survey;

FIG. 5 shows an example of a passive seismic receiver array;

FIG. 6 shows how passive seismic data acquisition can be optimized during a controlled source seismic survey using a backbone array and

FIG. 7 shows how passive seismic data acquisition can be optimized during a controlled source seismic survey using an outlier array.

The drawings are not necessarily to scale. Like numbers refer to like parts or steps throughout the drawings.

### DETAILED DESCRIPTION OF SOME EMBODIMENTS

Before proceeding with the detailed description, it is to be appreciated that the present teaching is by way of example only, not by limitation.

In the following description, specific details are provided to impart a thorough understanding of the various embodiments of the invention. Upon having read and understood the specification, claims and drawings hereof, however, those skilled in the art will understand that some embodiments of the invention may be practiced without adhering to some of the specific details set forth herein. Moreover, to avoid obscuring the invention, some well-known methods, processes and devices and systems finding application in the various embodiments described herein are not disclosed in detail. Persons having ordinary skill in the art will recognize that there may be many implementation-specific details that are not described here, but that would be considered part of a routine undertaking to implement the inventive concepts of the present invention.

Several embodiments of the present invention are discussed below. The appended drawings illustrate only typical embodiments of the present invention and therefore are not to be considered limiting of its scope and breadth. In the drawings, some, but not all, possible embodiments are illustrated, and further may not be shown to scale.

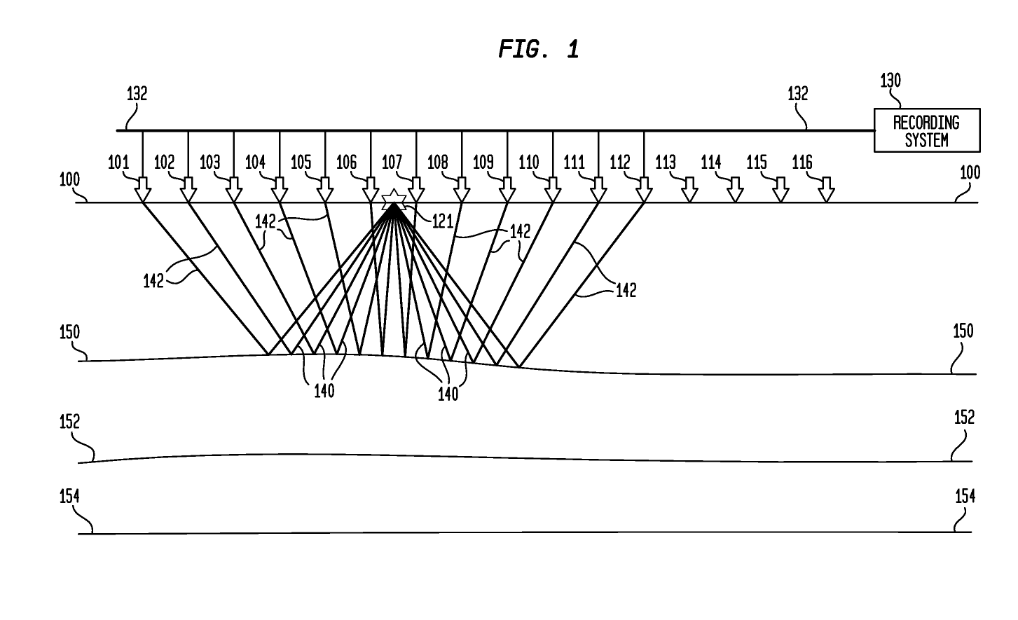

FIG. 1 shows a conceptual illustration of an early two-dimensional land seismic survey. Receivers 101-116 are positioned on or proximate the surface of the earth 100. For purposes of illustration surface of the earth 100 is shown as flat, but in most cases will contain variations in elevation. A seismic source 121 is activated on or proximate surface of the earth 100. In FIG. 1, receivers 101 through 112 are connected via cable 132 to recording system 130. When seismic source 121 is activated, the energy travels down via ray paths 140 to subsurface reflector 150, and is then reflected back up along ray paths 142 to all the receivers. Subsurface reflectors such as 150 represent discontinuities in the subsurface where the velocity of the sound waves changes. However, data for this source activation is only recorded at receivers 101 through 112. Seismic energy is also reflected back from many other reflectors, as shown at 152, 154. The ray paths down to these reflectors and back up to the receivers have been omitted for clarity.

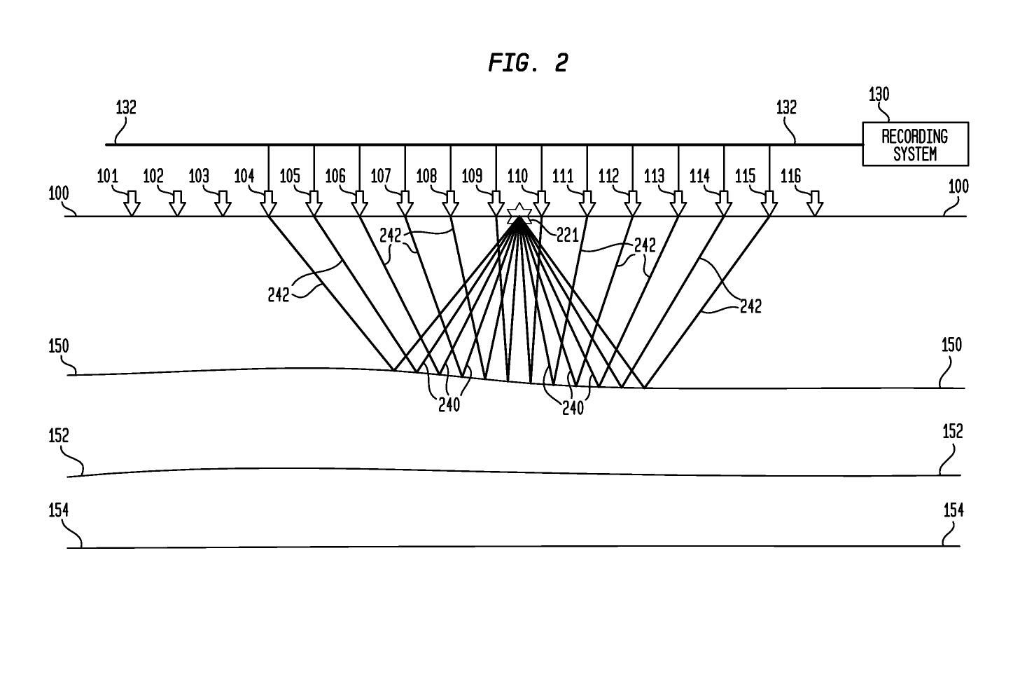

FIG. 2 shows the two-dimensional land seismic survey recording using a different set of receivers. In this example, seismic source 221 is activated and data is recorded from receivers 104 through 115. In this case the seismic energy travels from source 221 to reflector 150 along ray paths 240 and is reflected back along ray paths 242. Receivers 101 through 103 have been disconnected from recording system 130, and receivers 113 through 115 have been connected to recording system 130. This is done not by physically moving electrical connections, but rather by changing the position of a switch in recording system 130. Receivers 101 through 103 are collected by the receiver crew and moved to positions ahead of receiver 116, to continue the survey. This process, known as “roll-along”, is repeated until data has been acquired for the entire line. In practice, many more receivers will be placed in position before data collection begins in order to prevent delays in the data collection process. Recording system 130 may also be moved to different locations as the survey progresses.

As the technology evolved, far more than the 12 receivers shown in FIG. 1 and FIG. 2 were recorded. In order to reduce various types of noise and enhance the signal, multiple receivers in various configurations were used at each surface location rather than the individual receivers shown in FIG. 1 and FIG. 2.

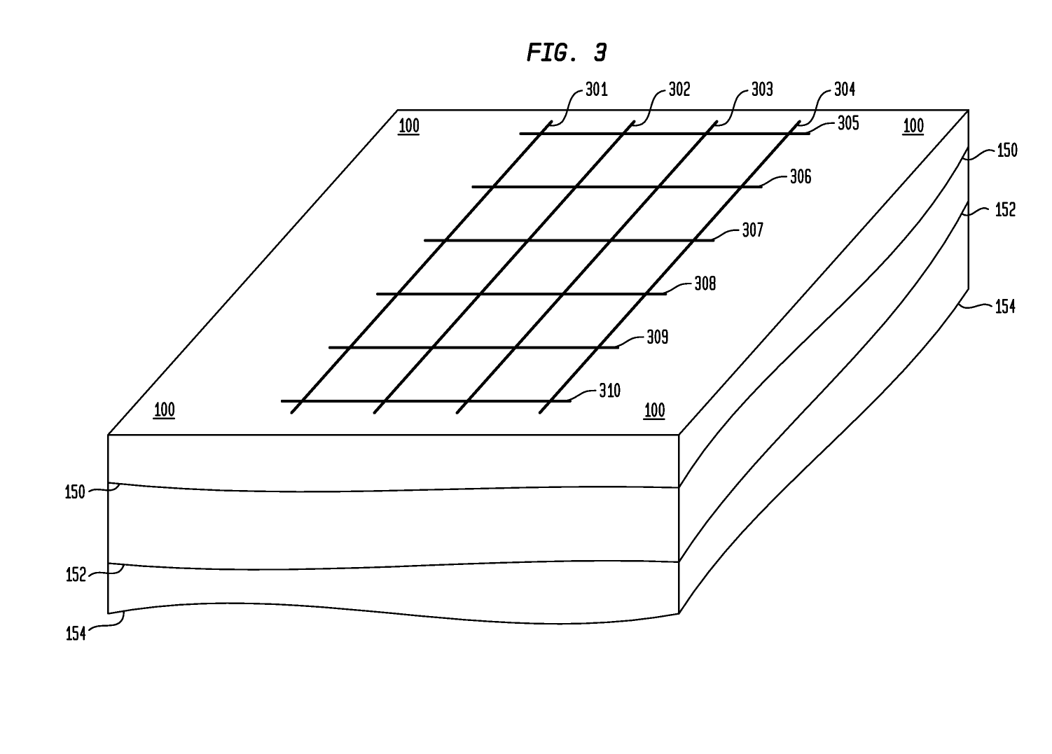

FIG. 3 shows a grid 300 of two-dimensional seismic lines 301 through 310. Data for each line is collected separately, and processed separately, to produce a two-dimensional image of the subsurface below that line. Then the various data sets are combined in a display to create an approximate three-dimensional image of the subsurface. The seismic lines in the grid are not necessarily orthogonal, and may be oriented to obtain the optimal image of the underlying geology. This approach has limitations, in that it assumes that the underlying geologic layers 150, 152, 154 are relatively flat. This assumption is required because two-dimensional seismic data processing assumes that the energy recorded is coming from directly below the line of receivers. Where the geologic layers, or faults in the subsurface, are not flat, then the seismic energy recorded at the receivers may have come from tilted reflectors in the subsurface to either side of the line

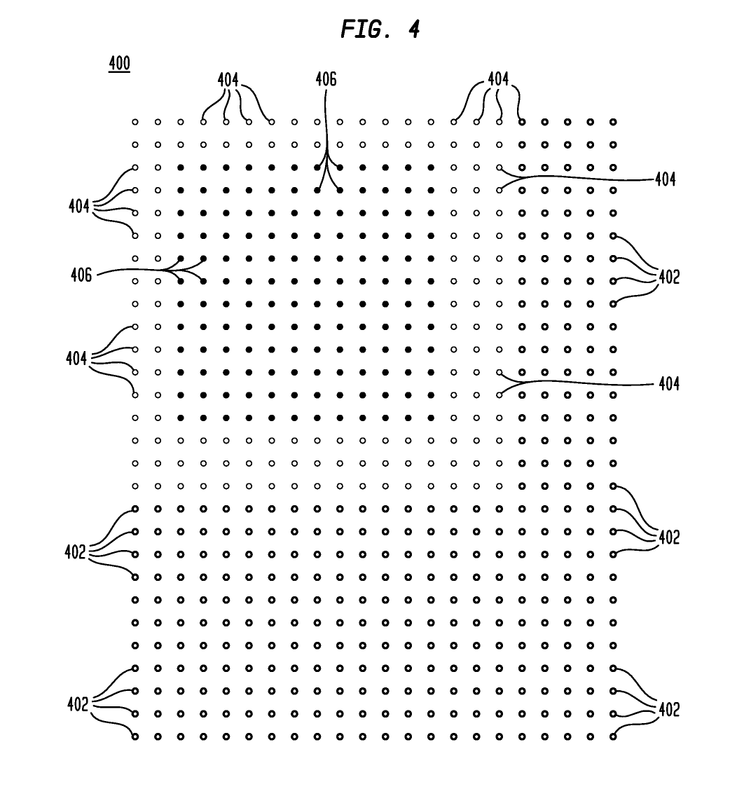

FIG. 4 shows a conceptual example of a three-dimensional seismic survey in plan view. When acquiring this type of data on land, receivers are usually laid out in a grid, or a series of substantially parallel lines to form a grid. This was the easiest method when the receivers were attached to cables. The introduction and widespread use of wireless receivers has greatly expanded the possible configurations and reduced the cost and complexity of placing the receivers. Surveys are not limited to rectangles or trapezoids, as the wireless receivers may be placed wherever they are needed to image the desired area of the subsurface. Often the wireless receivers are placed with the aid of GPS devices, and the receivers record or transmit their GPS coordinates along with the seismic data. For a small survey, all the receivers may be positioned before the survey begins. For larger surveys, the same considerations described above apply. A large survey may contain a huge number of receiver locations, in the hundreds or even thousands. It may be impractical to position all of the receivers before the survey begins. It may be too costly, or there may not be enough receivers available. The recording crew may not want or be able to wait until the receivers are all in position. For these and other reasons, only some fraction of the receiver stations may be populated when the survey begins.

FIG. 4 shows such a grid 400 with rows of surveyed receiver locations. Some of the receiver locations 402 do not contain receivers. Other receiver locations 404 do contain receivers. A sub-set of these receivers 406 is connected to the recording system. The sub-set of these receivers connected to the recording equipment, or activated wirelessly for a given source activation, is referred to as a “patch” or “receiver patch”. This receiver patch moves through the set of occupied receiver locations. Just as with the two-dimensional data acquisition, as the survey progresses, receivers are moved into new positions ahead of the recording crew, and the receiver patch moves accordingly so that the entire area can be surveyed. This is a less than ideal arrangement for passive seismic data acquisition, as there are large parts of the survey area where there are no receivers in position and thus no data can be recorded from these locations.

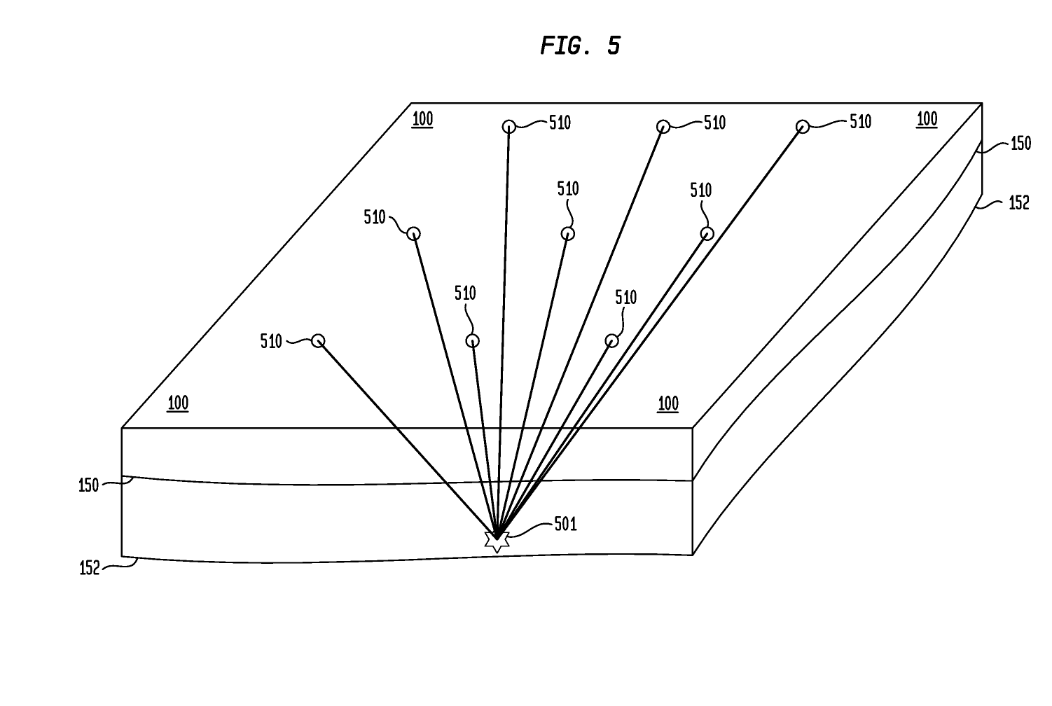

FIG. 5 shows an example of a passive seismic monitoring receiver array. Seismic energy is released from source 501 in the subsurface of the earth. The seismic energy travels through the subsurface of the earth to the receivers 510 on or proximate to surface of the earth 100. Data from these receivers is recorded over several hours or days. Using techniques adapted from earthquake seismology, it is possible to obtain information about where in the subsurface of the earth the seismic energy originated. Various configurations of receivers are used, depending on the objective of the survey. For earthquake monitoring, a sparse array consisting of a small number of receivers spaced far apart may be optimal. A similar arrangement was used for monitoring nuclear tests, which produce high amounts of seismic energy. The most common form of passive seismic recording performed today is monitoring of the development of an oil or gas field, especially where fracing is used to enhance production. Some operators record passive seismic data just during the fracing process. In that case, arrays such as a star array, centered on the well, may suffice, but are far from ideal.

For a discussion of some techniques used to image passive seismic data, see U.S. Pat. No. 6,389,361 to Geiser, entitled “Method for 4D Permeability Analysis of Geologic Fluid Reservoirs” and U.S. Pat. No. 7,127,353 to Geiser, entitled “Method and Apparatus for Imaging Permeability Pathways of Geologic Fluid reservoirs Using Seismic Emission Tomography”. See also U.S. Pat. No. 7,391,675 to Drew entitled “Microseismic Event Detection and Location by Continuous Map Migration” and U.S. Pat. No. 7,660,199 to Drew, also entitled “Microseismic Event Detection and Location by Continuous Map Migration”. See further U.S. Pat. No. 7,663,970 to Duncan et al., entitled “Method for Passive Seismic Emission Tomography”.

The trend in the industry is to monitor using passive seismic techniques the area from before the initial drilling through the development of the resources and into the production phase. The embodiments described here refer in particular to the recording of passive seismic data during the acquisition of controlled source seismic data. This survey may be in conjunction with development of natural resources, or may be a preliminary exploration survey. In such embodiments, the goal is to record passive seismic data over the whole survey area for the entire duration of the controlled source seismic survey.

Passive seismic surveys and controlled source surveys clearly have conflicting requirements for the configuration of the receivers. As described above, in a small scale survey it may be possible to place all the receivers for the survey prior to the start of the survey. It is therefore possible to select and use a sub-set of the receivers for the continuous recording required for the passive seismic survey. For larger surveys, typically only some of the planned receiver locations actually contain receivers at the onset of the controlled source survey. This is a problem for the associated passive seismic survey. The passive seismic survey is further complicated as the receivers change position during the controlled source survey, and the receivers do not stay in any one location long enough to collect the quantity of data required for a passive seismic survey

This conflict may be resolved by allocating a sub-set of the receivers to the passive seismic survey. This sub-set of receivers is positioned according to the design requirements of the passive seismic survey, covering the entire survey area with comparatively wide spacing. This embodiment is referred to as a “Backbone Array”. These receivers remain in place for the duration of the controlled source survey, and possibly beyond. The remaining receivers are then allocated to the controlled source receiver patch. The receiver patch then progresses across the survey area as described above.

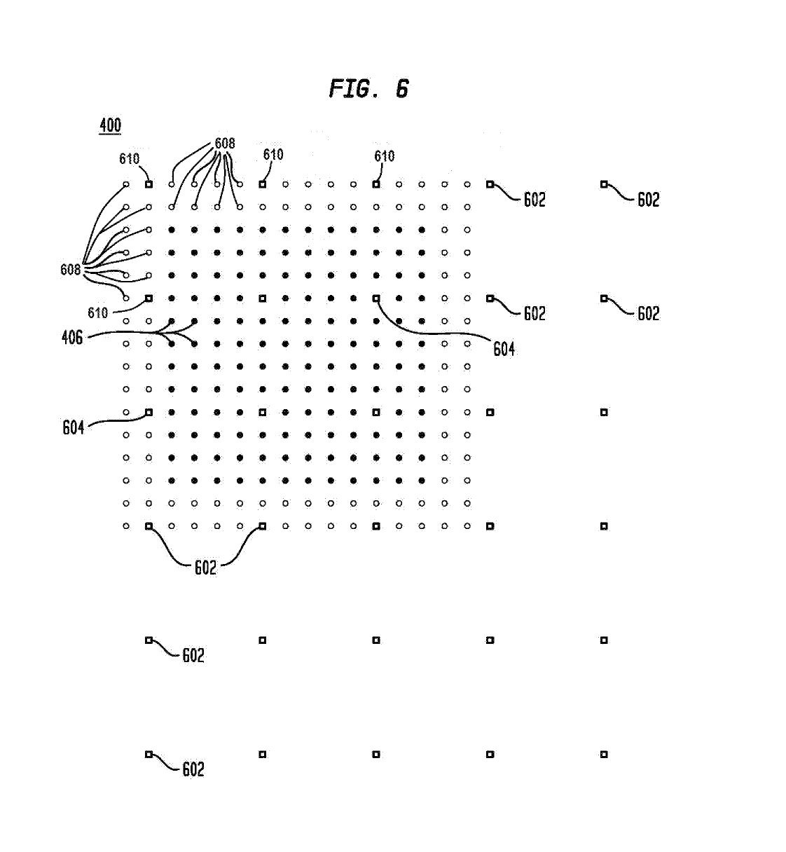

FIG. 6 shows how passive seismic data acquisition can be optimized during a controlled source seismic survey using a Backbone Array. In FIG. 6, surveyed locations 402 that do not contain receivers are not shown for clarity, although the survey area is the same as in FIG. 4. In addition to the controlled source receiver patch, receivers 602 are positioned at the required intervals across the entire survey area to form the Backbone Array which allows the recording of passive seismic data.

Some of the locations 604 for the receivers in the Backbone Array will be positioned within the area covered by the active receiver patch or within. In some embodiments, some of the receivers 406 in the active receiver patch are also used to record the passive seismic data. Other Backbone Array receivers 606 are within the subset of receivers already in place but not yet part of the active receiver patch. These receivers 604, 606 may be used to collect both passive and controlled source data. This embodiment requires extracting data for the duration of each controlled source recording from the continuous data set recorded for the passive seismic data. Some modern data acquisition systems use wireless receivers equipped with flash memory of sufficient capacity to record data for the entire duration of the survey, and use the extraction of data corresponding to each source activation as a standard procedure. The continuous data recording allows any receiver to be designated as part of the passive seismic array.

Some wireless recording systems do not record continuously. For example, some systems use receivers that transmit data over wireless links. This depletes the batteries in the receivers, so the data is often transmitted only when the controlled source is activated. Therefore receivers capable of storing or transmitting data continuously, or those that accumulate data and transmit in bursts, are required for the passive seismic data. That requirement precludes the use of some subset of the receivers for the Backbone Array. It is therefore assumed in the above discussion that the receivers used for the controlled-source seismic survey are of a type that is suitable for continuous recording of passive seismic data.

In the embodiment shown in FIG. 6, the initial area covered by the receivers is smaller than in FIG. 4, because some of the receivers have been distributed over the survey area for the purpose of recording the passive seismic data. This embodiment requires ensuring that sufficient receivers are available both for proper recording of the passive seismic data and that the remaining receivers positioned for the controlled source survey are at least sufficient to cover the active receiver patch.

In an alternative embodiment, the number of receivers required to support the roll-along requirements of the receiver patch is allocated to that purpose. The remaining receivers are then allocated to the passive seismic array, and distributed appropriately over the entire survey area. These receivers may be distributed uniformly over the entire survey area, although doing so does not take into account geologic or geophysical considerations. Because the position of each receiver is known accurately, an approximately uniform distribution, avoiding physical obstacles or sources of noise such as drilling sites, is acceptable.

The receivers used for the passive seismic array should be marked in some way, so that the receiver crew knows that they must be left in place as the receiver patch progresses and the other receivers are collected and repositioned ahead of the receiver patch. For example, in FIG. 6, receivers 610 are in use as part of the Backbone Array and must be left in position, while receivers 608 are ready to be collected and moved to a new position. When the receiver locations are surveyed by a surveying crew prior to placing the receivers, the locations for the Backbone Array will be marked in some way so that the crew laying out the Backbone Array knows where to place the receivers. These markers will suffice to alert the receiver crew to leave the receiver in place at that location. When the Backbone Array receivers are placed in predetermined locations using GPS technology, then they should be identified in some way.

Although FIG. 6 shows receivers 602 for the Backbone Array in locations that form part of the pattern seen in the controlled source seismic survey grid 400, for the purposes of the passive seismic survey, the receivers may be in locations that are more suitable or convenient. The reason for placing the Backbone Array receivers at the grid locations is so that when the controlled source seismic survey reaches a Backbone Array receiver 602, it can form part of the controlled source seismic survey array, thus using the receivers most efficiently.

There are many advantages to be gained from acquiring passive seismic data in an area to accompany a controlled source seismic survey. For example, for travel-time tomography and receiver function analyses, a multitude of teleseismic events with the correct characteristics is required for the analyses. More events can be recorded over the entire survey using a Backbone passive seismic array than can be recorded by a rolled receiver array. These two analyses do not require the receiver density that traditional controlled source 3D reflection surveys require. For the Backbone Array, 16 receivers per square mile may be quite adequate, versus 200 receivers per square mile for the controlled source survey.

Another example is using a Backbone Array to achieve proper offset data for ambient noise tomography. Ambient noise tomography uses receivers as “virtual sources” for cross-correlation with other receivers that are recording during the same time period. Achieving a good result in ambient noise tomography requires appropriate offsets between virtual sources and other receivers. If data is acquired using only rolled patch receivers, the offsets between a virtual source and a particular receiver is probably less than is required for a good analysis. Using a Backbone Array, some of the backbone receivers used as virtual sources will provide much longer offsets than can be achieved when using a rolled receiver patch only.

The passive seismic data may also be used in ambient noise tomography, that is, tracking surface wave fronts across an array of seismometers. For a discussion of eikonal tomography, which is a subset of ambient noise tomography, see Lin, Riztwoller and Sneider, “Eikonal tomography: surface wave tomography by phase front tracking across a regional broad-band seismic array”, Geophys. J. Int. (2009) 177, 1091-1110

A further use of passive seismic data may be for the technique of daylight imaging. For a discussion of this technique, see Kees Wapenaar. “Acoustic Daylight Imaging”.

These and other geophysical techniques based on passive seismic data will be familiar to one of ordinary skill in the art, and the application of the embodiments described herein will be apparent after reading this description. The passive seismic data may also be used to obtain and refine seismic velocity information that may be used in the processing of data from the controlled source seismic survey.

These different types of analysis may require different distributions and densities of receivers, depending on the various geophysical and geological objectives. In order to acquire a dataset that is useful for all of these analysis techniques and more, the densest configuration of receiver locations should be used.

There is no requirement that would limit the distribution of receivers in the passive seismic array to the boundary of the three-dimensional controlled source survey. Indeed, there are good reasons for extending the passive seismic array well beyond the boundaries of the controlled source seismic survey. If the passive seismic data is acquired using receivers only within the boundaries of the controlled source seismic survey, the processed results suffer from boundary effects with the data at the edges of the survey area being degraded compared to data in the center of the survey area.

Therefore the Backbone Array may be deployed only within a three-dimensional survey boundary, or in other embodiments the Backbone Array may be deployed within the three-dimensional survey boundary, in conjunction with an “Outlier” receiver array located outside of the survey boundary. The distribution of receivers in the Outlier array is determined by the requirements of the passive seismic survey, including such factors as the depths of the events to be imaged, geological and geophysical considerations, and the ease of physical access. Typically the spacing of the receivers in the Outlier array will be the same as, or comparable to, the spacing of the receivers in the Backbone Array within the controlled source seismic survey area. It is convenient to regard the Outlier Array as an extended version of the Backbone Array.

The design of the Outlier Array follows the principles stated above for the Backbone Array. Travel-time tomography and receiver function analysis requires extension of the Outlier Array out in all directions from the controlled source seismic survey boundary to sufficiently capture all usable emergence angles of teleseismic events. Ambient noise tomography analysis requires, at a minimum, an array of receivers at a distance of three to four times the expected depth of imaging around the perimeter of the controlled source seismic survey. The spacing between receivers around the perimeter, at a maximum, should be about twice the expected imaging depth.

Designing Outlier Arrays for other analyses would need to be based on modeling. Any design method should account for any potential geophysical or geological considerations, but even a minimal Outlier array will be useful to passive data analyses. To collect an Outlier dataset to satisfy the requirements of all of the possible analyses, the analysis that has densest receiver requirement should be chosen as the basis for the survey design.

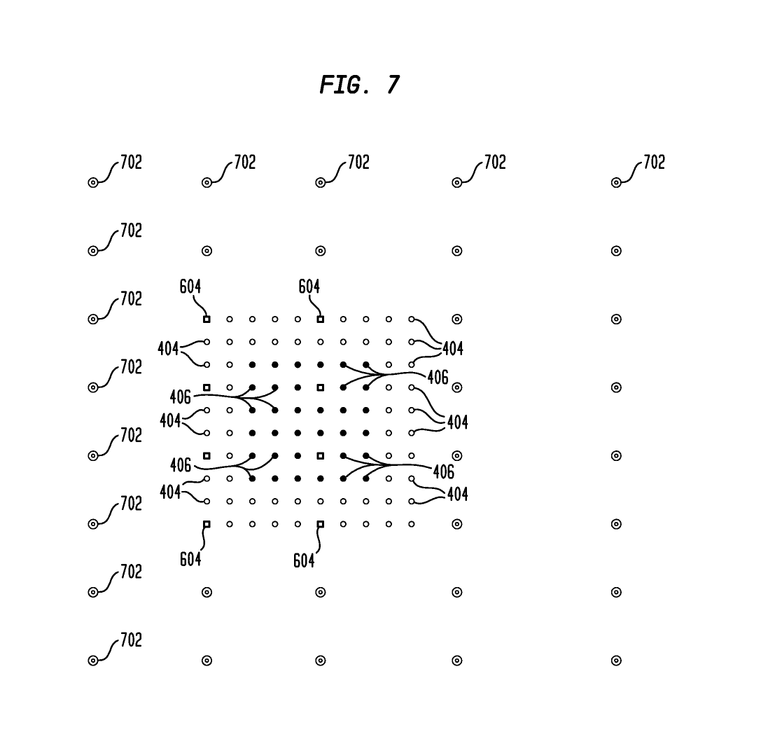

FIG. 7 shows how passive seismic data acquisition can be optimized during a controlled source seismic survey using an Outlier Array. In FIG. 7, the entire controlled source seismic survey area is shown with receivers 404 in place, and the patch of active receivers 406 is shown within this area. In embodiments where there are receiver positions 402 that do not contain geophones, the Backbone Array approach describe above may be used to provide receiver coverage for the passive seismic survey using receivers 604. In FIG. 7, the controlled source receiver patch is shown as half the size of that in FIG. 6, again for clarity. In practice, the controlled source seismic survey area would be far larger than shown and the active receiver patch would contain hundreds or thousands of receivers 406. Receivers 702 in the Outlier Array are positioned at the required intervals outside of the controlled source seismic survey area, which allows the recording of the passive seismic data with the correct distances and separations to perform the various analyses on the recorded data.

As the Outlier array receivers are outside of the controlled source seismic survey area, there are no constraints on where they are positioned. They will not form part of the controlled source seismic survey receiver grid, and thus do not have to follow any pattern established for the controlled source seismic survey. The Outlier Array receivers can be positioned with greater flexibility. As long as their positions are known, the receivers can be positioned with regard to both the design of the survey and the physical restrictions in the survey area, such as noise sources, terrain, lakes, roads, and other obstacles. As stated above, the receivers use GPS technology to record their position as they record the seismic data. This information is used when processing the data to image the subsurface.

The only potential downside to the Backbone Array and the Outlier Array is that they require that some of the receiver crew personnel be allocated to distributing and placing the Backbone Array, and possibly an Outlier Array, which are more geographically dispersed than the controlled source array and therefore take longer to set up. Typically the passive seismic be set up before or at the same time as the controlled source receiver patch. There will also be additional time required to collect the Backbone Array and Outlier array receivers once the survey has been completed.

A limited number of embodiments have been described herein. Those skilled in the art will recognize other embodiments within the scope of the claims of the present invention.

It is noted that many of the structures, materials, and acts recited herein can be recited as means for performing a function or step for performing a function. Therefore, it should be understood that such language is entitled to cover all such structures, materials, or acts disclosed within this specification and their equivalents, including any matter incorporated by reference.

It is thought that the apparatuses and methods of embodiments described herein will be understood from this specification. While the above description is a complete description of specific embodiments, the above description should not be taken as limiting the scope of the patent as defined by the claims.

Other aspects, advantages, and modifications will be apparent to those of ordinary skill in the art to which the claims pertain. The elements and use of the above-described embodiments can be rearranged and combined in manners other than specifically described above, with any and all permutations within the scope of the disclosure.

Although the above description includes many specific examples, they should not be construed as limiting the scope of the method, but rather as merely providing illustrations of some of the many possible embodiments of this method. The scope of the method should be determined by the appended claims and their legal equivalents, and not by the examples given.

What is claimed is:

1. A method for acquiring passive surface seismic data during a controlled source active seismic survey comprising:
determining the number of receivers required to support the recording of an active seismic data set and a passive surface seismic data set, the receivers being capable of recording active and passive seismic data;
deploying the receivers required to support the roll-along of an active receiver patch for recording controlled source seismic data in an initial active receiver patch and designating these receivers as active seismic data receivers;
deploying receivers in an approximately uniform distribution within the entire survey area to support the acquisition of a passive seismic data set and designating these receivers as passive seismic data receivers;
designating certain receivers within the initial active receiver patch as both active and passive receivers;
deploying additional receivers outside of the boundaries of the survey area to support the acquisition of an optimized passive seismic data set and designating these receivers as passive seismic data receivers;
initiating the recording of a passive surface seismic data set using the receivers designated as passive seismic data receivers;
recording a controlled source seismic data set for the survey area using the receivers designated as active seismic data receivers and
terminating the recording of the passive seismic data set.

2. The method of claim 1 wherein the passive seismic data set is optimized for ambient noise tomography.

3. The method of claim 1 wherein the passive seismic data set is optimized for travel-time tomography.

4. The method of claim 1 wherein the passive seismic data set is optimized for receiver function analysis.

5. The method of claim 1 wherein the passive seismic data set is optimized for ambient noise correlation.

6. The method of claim 1 wherein the passive seismic data set is optimized for velocity analysis.

7. The method of claim 1 wherein the passive seismic data set is optimized to eliminate boundary effects at the edges of the controlled source seismic survey area.

8. The method of claim 1 wherein the passive seismic data set is optimized for inferometric imaging.

9. The method of claim 1 wherein the passive seismic data set further comprises one-component data.

10. The method of claim 1 wherein the passive seismic data set further comprises three component data.

11. The method of claim 1 wherein the passive seismic data set further comprises four component data consisting of three component data plus pressure.
